(19) United States
(12) Patent Application Publication
(10) Pub. No.: US 2019/0164329 A1
(43) Pub. Date: May 30, 2019

(54) VIRTUAL REALITY DEVICE, IMAGE PROCESSING METHOD, AND NON-TRANSITORY COMPUTER READABLE STORAGE MEDIUM

(71) Applicant: HTC Corporation, Taoyuan City (TW)

(72) Inventors: Yu-Ting WU, Taoyuan City (TW); Chun-Wen CHENG, Taoyuan City (TW); Ching-Yang CHEN, Taoyuan City (TW)

(21) Appl. No.: 16/205,244

(22) Filed: Nov. 30, 2018

Related U.S. Application Data
(60) Provisional application No. 62/592,419, filed on Nov. 30, 2017.

(51) Int. Cl. G06T 15/04; G06T 19/20

(52) U.S. Cl. CPC G06T 15/04; G06T 19/20; G06F 3/0346; G06T 2200/24; G06T 2219/2012

(57) ABSTRACT

The present disclosure provides a virtual reality (VR) device, an image processing method, and a non-transitory computer readable storage medium. The VR device includes a display and a processor. The display is configured to display a VR object. The processor is configured to receive a control instruction, and acquire, on the VR object, an indicating region according to the control instruction; acquire, on the indicating region, a control region associated with a 2D image; acquire a 3D normal mapping data corresponding to the indicating region; calibrate a range of the control region according to a position information of the control instruction and the 3D normal mapping data; and edit, on the calibrated range, the control region according to the received control instruction.

### CROSS-REFERENCE TO RELATED APPLICATION

This application claims priority to U.S. Provisional Application Ser. No. 62/592,419, filed on Nov. 30, 2017, which is herein incorporated by reference.

### BACKGROUND

### Technical Field

The present disclosure relates to a processing device and method. More particularly, the present disclosure relates to an image processing device and method.

### Description of Related Art

Traditionally, there is a texture edition method for the three-dimensional model, that is, the three-dimensional model is UV mapping into 2D images. The user must adjust the contents of 2D images by the mouse cursor to perform editions for three-dimensional model.

However, the image process said above is not an intuitive way, and strong dependents on user's edition experiences. In addition, the virtual reality products are targeted at average people. The foregoing cannot provide the average people to operate the edition. Hence, how to provide an intuitive way for editing the three-dimensional model is the problem must to be solved.

### SUMMARY

One aspect of the present disclosure is related to an image processing device. In accordance with some embodiments of the present disclosure, the image processing device includes a display device and a processor. The display device is configured to display a virtual reality object; the processor, coupled to the display device is configured to: receive a control command, and receive a indicated region on a virtual reality object according to a control command; read a control block of a 2D image associated with the indicated region; read a 3D normal vector mapping data associated with the indicated region; calibrate a range the control block according to a position data of the control command and the 3D normal vector mapping data; and edit, in the calibrated range, a content of the control block according to the received control command.

Another aspect of the present disclosure is related to an image processing method. In accordance with some embodiments of the present disclosure, the image processing method includes: receiving a control command, and obtaining an indicated region on a virtual reality object according to the control command; reading a control block of a 2D image associated with the indicated region; reading a 3D normal vector mapping data corresponding to the indicated region; calibrating a range of the control block according to a position data of the control command and the 3D normal vector mapping data; and editing, in the calibrated range, a content of the control block according to the received control command.

Another aspect of the present disclosure is related to a non-transitory computer readable storage medium. In accordance with some embodiments of the present disclosure, the non-transitory computer readable storage medium stores one or more programs including instructions, which when executed, causes a processing circuit to perform operations including: receiving a control command, and obtaining an indicated region on a virtual reality object according to the control command; reading a control block of a 2D image associated with the indicated region; reading a 3D normal vector mapping data corresponding to the indicated region; calibrating a range of the control block according to a position data of the control command and the 3D normal vector mapping data; and editing, in the calibrated range, a content of the control block according to the received control command.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as follows:

FIG. 1 is a schematic block diagram illustrating a communication scenario between a virtual reality (VR) device and a controller in accordance with some embodiments of the present disclosure.

FIG. 2A is a diagram illustrating editing an appearance of a Virtual reality object in a VR environment.

FIG. 2B is a diagram illustrating a plurality of texture images mapped from the Virtual reality object.

FIG. 2C is a diagram illustrating an appearance of the edited Virtual reality object in the VR environment.

FIG. 3 is a diagram illustrating editing the appearance of the Virtual reality object in accordance with some embodiments of the present disclosure.

FIG. 4A is a diagram illustrating reading a position mapping data and a normal mapping data in accordance with some embodiments of the present disclosure.

FIG. 4B is a diagram illustrating calibrating an indicated region in accordance with some embodiments of the present disclosure.

FIG. 5A is a diagram illustrating the control block 227 of a 2D image in accordance with some embodiments of the present disclosure.

FIG. 5B is a diagram illustrating the appearance of the edited Virtual reality object in accordance with some embodiments of the present disclosure.

FIG. 6 is a flowchart illustrating an image processing method in accordance with some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

It will be understood that, in the description herein and throughout the claims that follow, when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Moreover, “electrically connect” or “connect” can further refer to the interoperation or interaction between two or more elements.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, words indicating direction used in the description of the following embodiments, such as “above,” “below,” “left,” “right,” “front” and “back,” are directions as they relate to the accompanying drawings. Therefore, such words indicating direction are used for illustration and do not limit the present disclosure.

It will be understood that, in the description herein and throughout the claims that follow, unless otherwise defined, all terms (including technical and scientific terms) have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. § 112(f). In particular, the use of “step of” in the claims herein is not intended to invoke the provisions of 35 U.S.C. § 112(f).

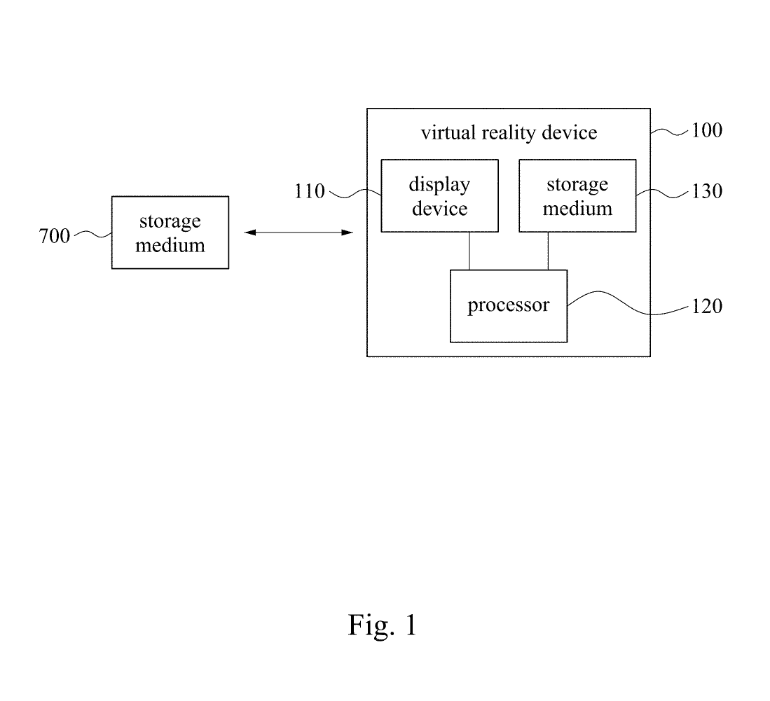

Reference is made to FIG. 1. FIG. 1 is a schematic block diagram illustrating a communication scenario between a virtual reality (VR) device 100 and a controller 700 in accordance with some embodiments of the present disclosure. As shown in FIG. 1, the controller 700 is configured to generate a control command, and transmits the control command to the virtual reality device 100.

The virtual reality device 100 includes a display device 110, a processor 120 and a storage medium 130. The processor 120 is coupled to the display device 110 and the storage medium 130. The storage medium 130 is configured to store a plurality of texture images, a position mapping data and a normal vector mapping data. The display device 110 is configured to display a virtual reality object. The processor 120 is configured to execute an image editing procedure on the virtual reality object in a virtual reality environment. In some embodiments, a user can hold the controller 700 in his/her hand, and watch screens and objects of the virtual reality environment on the display device 110.

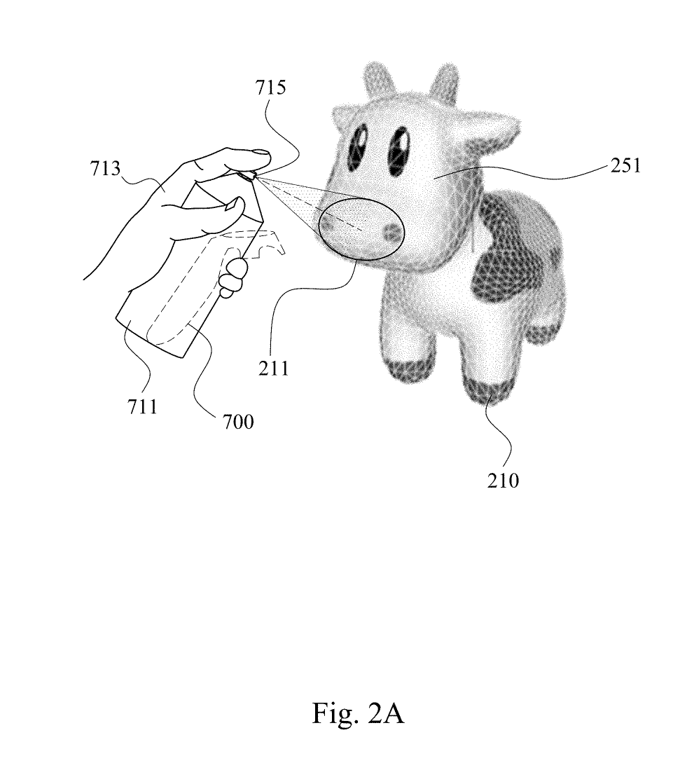

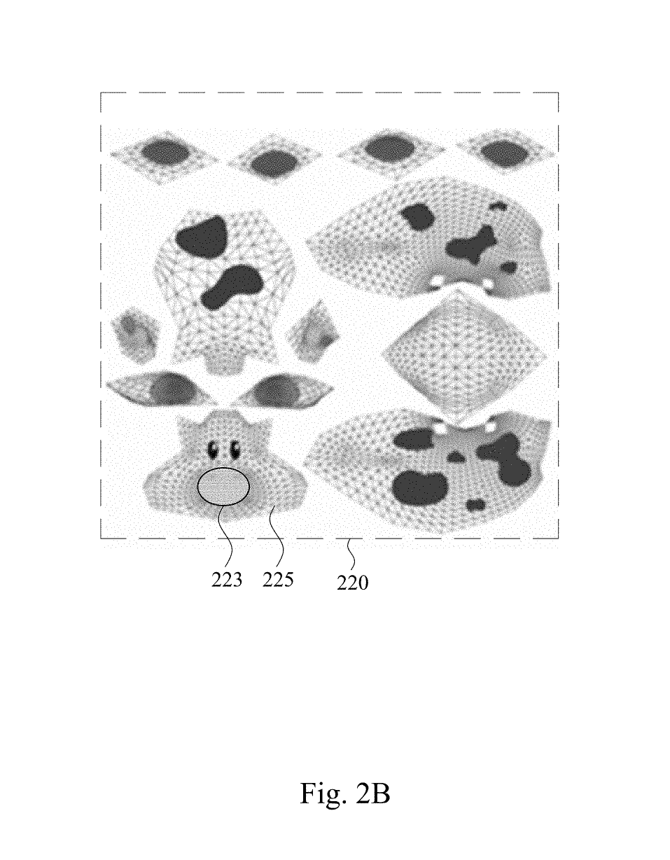

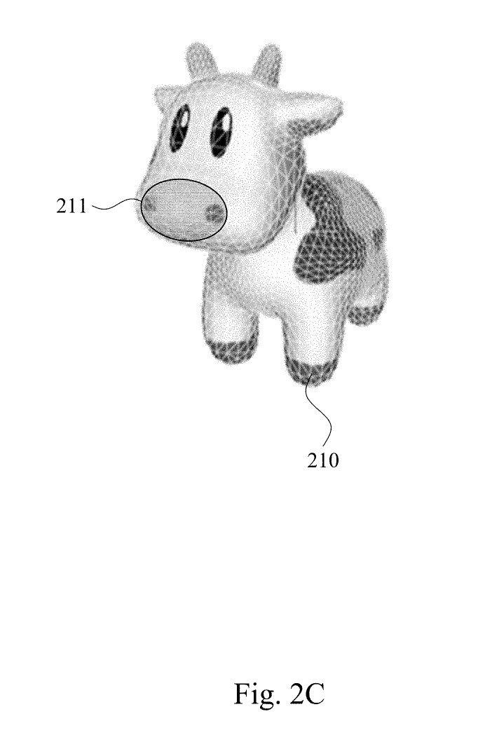

Reference is made to FIG. 2A. FIG. 2A is a diagram illustrating of editing an appearance of a Virtual reality object 210 in a VR environment. The screen shown as FIG. 2A is displayed on the display device 110. The user can see a virtual hand 713 and a virtual spray-painting can 711 held by a virtual hand 713.

The virtual spray-painting can 711 comprises a virtual spray nozzle 715. The user uses a control button (not shown) of the controller 700, that is, the virtual hand 713 pushes the virtual spray nozzle 715 and sprays on the virtual reality object 210 (such as the cow shown in FIG. 2A), to edit an appearance of the virtual reality object 210 (e.g. colors, figures or patterns, etc.). The virtual spray nozzle 715 is at a distance from the virtual reality object 210, and then there is an editing range corresponding to the appearance of the virtual reality object 210. In some embodiments, a spray angle of the virtual spray nozzle 715 can be set previously. Then, when the spray distance is fixed, the larger the spray angle is, the larger the spray range is. After repeated spraying procedure, an indicated region 211 will be gradually broadening along with the spraying action. Hence, the virtual spray nozzle 715 will make sprays on the indicated region 211. When the appearance of the cow's (the virtual reality object 210) nose (the indicated region 211) is edited, a distance and a related angle between the virtual spray nozzle 715 and the virtual reality object 210 can be changed according to actual demands, to adjust the size of the indicated region 211 and the range of the indicated region 211 on the virtual reality object 210.

Reference is made to FIG. 2B. FIG. 2B is a diagram illustrating a plurality of texture images 225 mapped from the virtual reality object 210. As shown in FIG. 2B, by using an editor such as the UV mapping editor, 3D images of the virtual reality object 210 will be decomposed into a plurality of texture images such as the texture image 225 with two-dimensional format. The texture images including texture image 225 are stored by the format shown as 2D image 220. The virtual reality object 210 comprises a plurality of object blocks, and each of the texture images will correspond to one object block. For example, the texture image 225 corresponds to face of the cow (the object block 251). In some embodiments, the indicated region 211 (as shown in FIG. 2A) of the virtual reality object 210 will correspond to the control block 223 of the texture image 225 (as shown in FIG. 2B). In the editing procedure, contents of the texture image 225 in the range of the control block 223 will be edited.

Reference is made to FIG. 2C. FIG. 2C is a diagram illustrating an appearance of the edited virtual reality object 210 in the VR environment. The edited image contents of the control block 223 (as shown in FIG. 2B) can be displayed correspondingly on the indicated region 211 (as shown in FIG. 2C) to show the changed contents. The appearance of the virtual reality object 210 is edited to finish the procedure of editing the appearance of the virtual reality object 210.

In some circumstances, while the virtual reality object 210 is edited, some ranges (such as the cow's chin area) indicated by the virtual spray nozzle 715 are also edited, that is, the control block 223 of the texture image 225 will be edited. The edited result is shown as the cow's chin (i.e. the indicated region 211 shown in FIG. 2C). However, in the virtual reality environment, the cow's chin area may be sheltered from the cow's nose. In the circumstances, it does not conform the stereoscopic editing effect while the chin part of the cow is simultaneously edited.

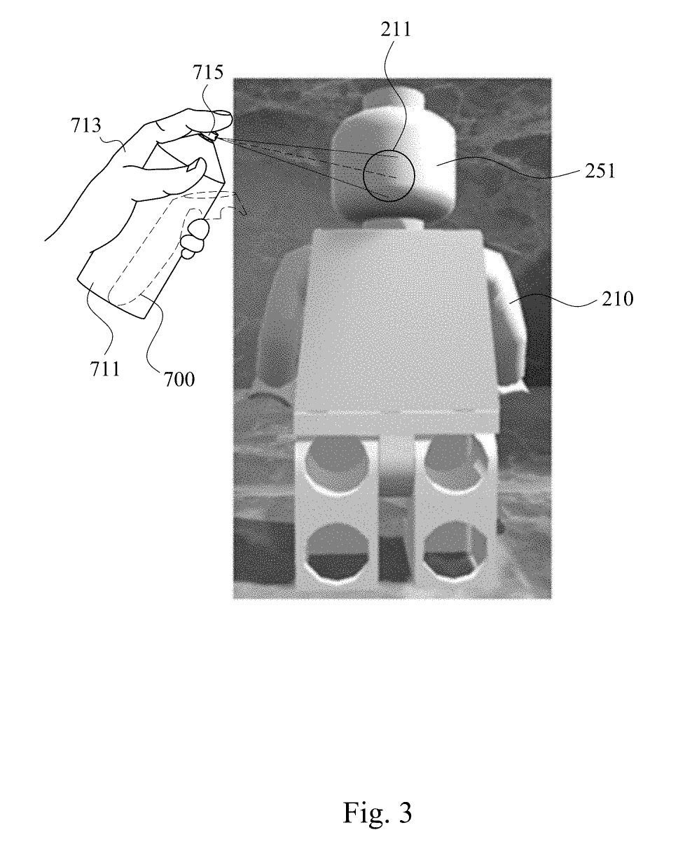

Reference is made to FIG. 3. FIG. 3 is a diagram illustrating editing the appearance of the Virtual reality object in accordance with some embodiments of the present disclosure. As shown in FIG. 3, the virtual reality object 210 is a toy in the virtual reality environment. The user operates the controller 700, and could see that the virtual hand 713 handhelds the virtual spray-painting can 711 on the display device 110 (as shown in FIG.1). Therefore, the region which is to be edited could be indicated by the virtual spray nozzle 715. The region is illustrated as indicated region 211 in FIG. 3.

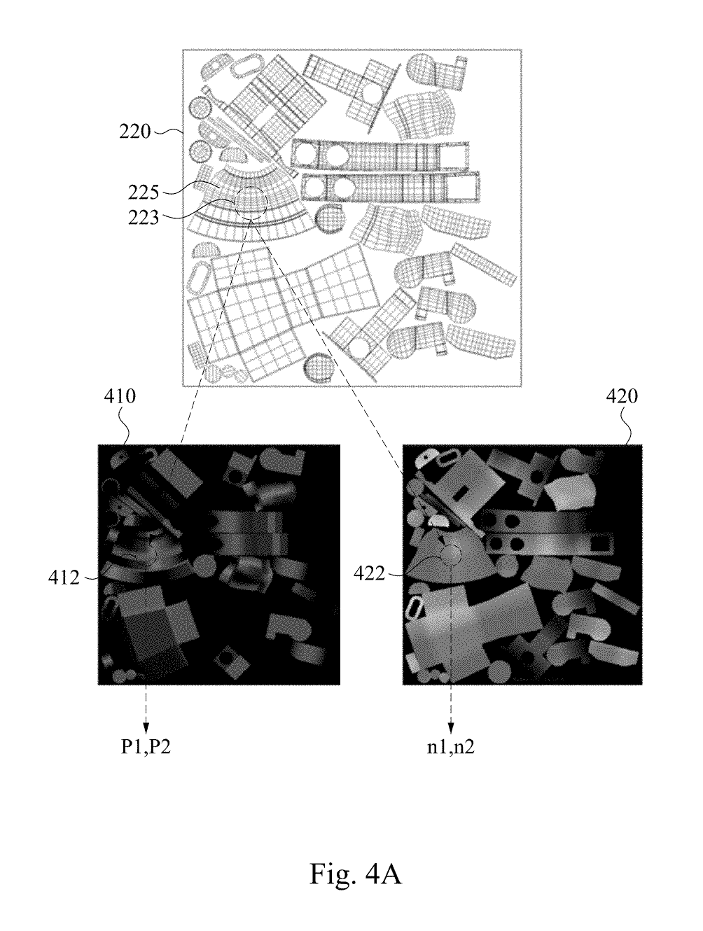

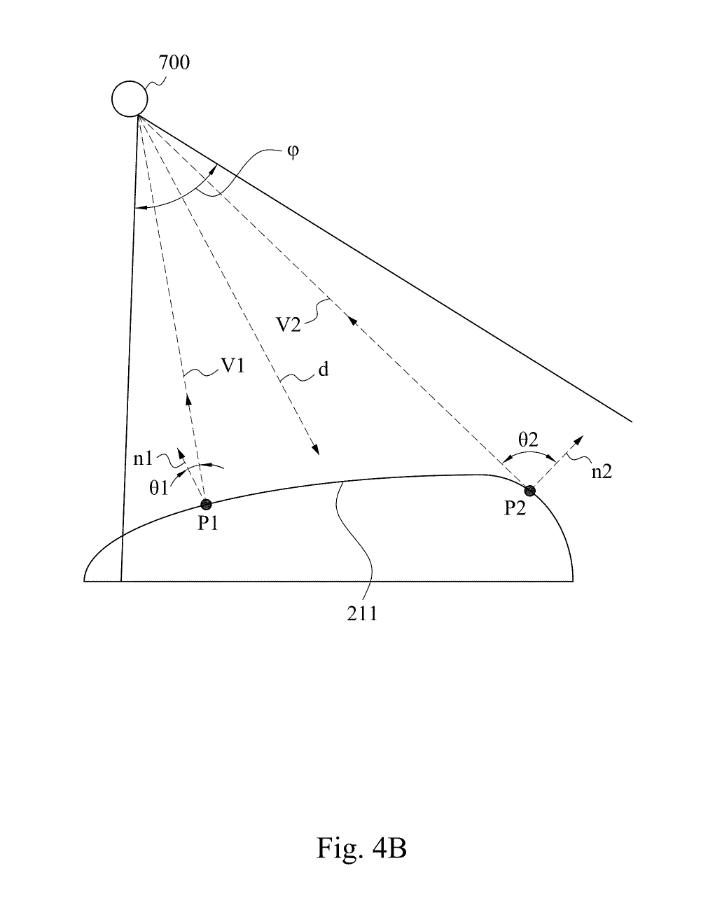

Reference is made to FIG. 4A. FIG. 4A is a diagram illustrating reading a position mapping data and a normal mapping data in accordance with some embodiments of the present disclosure. As shown in FIG. 4A, a plurality of texture images such as texture image 225 of the 2D image 220 are two-dimensional UV-mapping images of the virtual reality object 210 in FIG. 3. Please referring to FIG. 4A with FIG. 1 and FIG. 3, the user operates the controller 700 to, for example, point to the virtual reality object 210 by operating the virtual spray nozzle 715. The user push the button (not shown) of the controller 700, and the controller 700 generates a data including a position data of the controller 700 (such as a three-dimensional coordinate) and a control command of editing instructions. The editing instructions are, for example, instructions of painting objects. The virtual reality device 100 receives the control command, and the processor 111 executes related image processing procedure. First, the processor 111 retrieves the indicated region 211 on the virtual reality object 210. For example, a three-dimensional sensor (not shown) of the controller 700 determines positions or azimuth which the controller 700 directs to, and transfers to the position of the virtual reality environment. The processor 120 obtains the control block 223 of the 2D image 220. In some embodiments, the control block 223 is one part of the texture image 225. It should be noted that, the indicated region 211 may map to one or more parts (such as control block 223) of the texture image 225 according to the position of the indicated region 211.

A position mapping data 410 records the mapping data between each of the texture images and each object block of the virtual reality object 210. For example, the texture image 225 is a two-dimensional image storing two-dimensional coordinates. An object block 251 is a three-dimensional image, and each of pixels thereof comprises three-dimensional coordinates. The position mapping data 410 records mapping relations between two-dimensional coordinates of pixels of the texture image 225 and three-dimensional coordinates of pixels of the object block 251 corresponding to the texture image 225. By querying the mapping relations of the position mapping data 410, the texture image 225 to which part of the virtual reality object 210 is mapping could be found out, and vice versa. In some embodiments, the processor 120 queries the position mapping data 410 according to the two-dimensional coordinates of pixels of the control block 412, to obtain the three-dimensional coordinates of pixels of the indicated region 211.

A normal vector mapping data 420 records mapping relations between the two-dimensional coordinates of pixels of the texture image 225 and the three-dimensional normal vectors of pixels in object blocks of the virtual reality object 210. For example, the texture image 225 is the two-dimensional image, and each pixel of the texture image 225 correspondingly records the two-dimensional coordinate. The object block 251 is the three-dimensional image, and each pixel of the object block 251 correspondingly records the three-dimensional normal vector. The normal vector mapping data 420 records mapping relations between the two-dimensional coordinates of pixels of the texture image 225 and the three-dimensional normal vectors of pixels of the object block 251 corresponding to the texture image 225. In some embodiments, the processor 120 queries the normal vector mapping data 420 by using the two-dimensional coordinates of pixels of the control block 422, to obtain the three-dimensional normal vectors of pixels of the object block 251.

The following illustrates that, in respond to reading the control block 223, the virtual reality device 100 is how to calibrate the range of the control block 223 such that the spraying result conforms the stereoscopic effect in accordance of the present disclosure.

Reference is made to FIG. 4B. FIG. 4B is a diagram illustrating calibrating an indicated region 211 in accordance with some embodiments of the present disclosure. As shown in FIG. 4B, the indicated region 211 is a side view of the virtual reality object 210 in FIG. 3. In some embodiments, the indicated region 211 in FIG. 4B illustrates the side sketch of part of the virtual reality object 210 of FIG. 3.

Please referring to FIG. 4B in conjunction with FIG. 1, when the controller 700 transmits the control command, the processor 120 calculates the direction vector between the position data in the virtual reality space (such as the three-dimensional coordinate of the controller 700) of the control command and the three-dimensional coordinates of pixels of the indicated region 211. The three-dimensional coordinate of pixels of the indicated region 211 can be obtained by querying the position mapping data 410. In some embodiments, the direction vector V1P1 can be calculated by the three-dimensional coordinate of pixel P1 and the three-dimensional coordinate of the controller 700.

The processor 120 queries the normal vector mapping data 420, to obtain the three-dimensional normal vector n1 of the pixel P1 of the indicated region 211. The processor 120 calculates the angle θ1 between the direction vector V1 and the three-dimensional normal vector n1. When the processor 120 determines the angle is not larger than a threshold, the pixel is considered to be part of the range to be edited. For example, the angle θ1 is not more than angle 90°, then it is not necessary to exclude the pixel P1 from the control block 223 (as shown in FIG. 4A).

Similarly, there is a pixel P2 containing a direction vector V2 in the indicated region 211. The processor 120 queries the normal vector mapping data 420, to obtain the three-dimensional normal vector n2 of the pixel P2 in the indicated region 211. The processor 120 calculates an angle θ2 between the direction vector V2 and the three-dimensional normal vector n2. Because the angle 82 is larger than the threshold angle 90°, then the processor 120 excludes the pixel P2 from the range to be edited in the control block 223 (as shown in FIG. 4A).

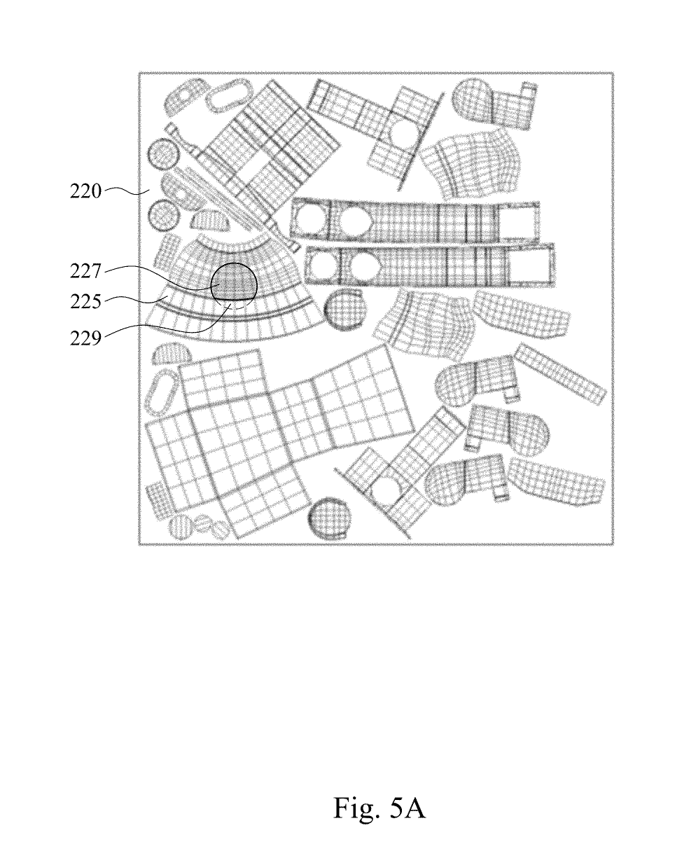

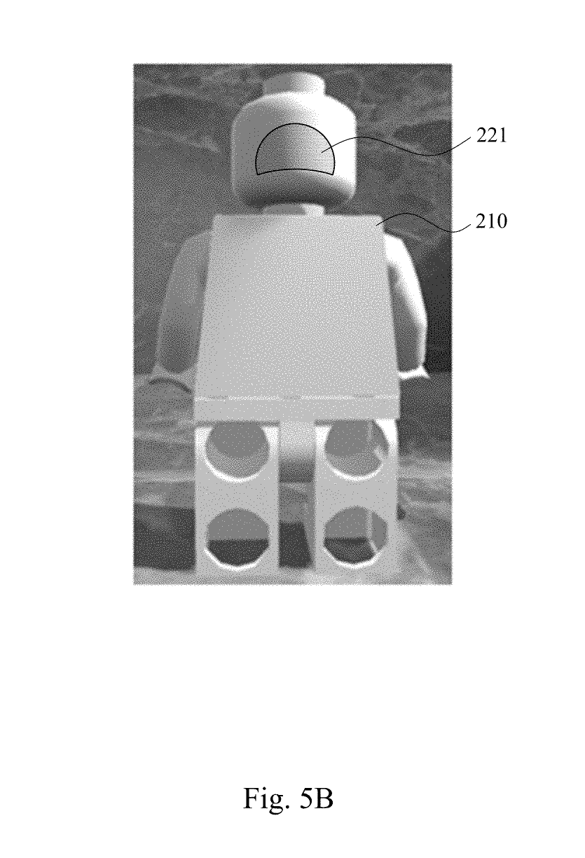

Reference is made to FIG. 5A. FIG. 5A is a diagram illustrating the control block 227 of a 2D image 220 in accordance with some embodiments of the present disclosure. As shown in FIG. 5A, the control block 227 is the range after excluding some pixels (as the black portion). The pixels which are excluded are, for example, the block 229 (as the white portion). The block 229 will not be edited. In other words, only the range within the control block 227 will be sprayed or edited.

Reference is made to FIG. 5B. FIG. 5B is a diagram illustrating the appearance of the edited virtual reality object 210 in accordance with some embodiments of the present disclosure. As shown in FIG. 5B, the spraying range on the virtual reality object 210 is not completely the range pointed by the virtual spray nozzle 715. Only part of the indicated region 211 (such as the black portion) will be edited, and the area near or of the shadow will not be sprayed or edited. That is, the concave part or the shadow part of the virtual reality object 210 should not be sprayed or edited for stereoscopic effect while the spraying directs to the object surface.

Therefore, the present disclosure provides users to spray or edit the virtual reality object in the virtual reality environment with reasonable stereoscopic effect. In the spraying range, the pixels (if they are edited) which do not fit stereoscopic effect are founded and then excluded from the edited range according to the three-dimensional space logic. Hence, the spraying result is more realistic in the virtual reality environment. For example, the user takes the virtual spray-painting can to spray the head part object block of the virtual reality object 210 in FIG. 5B, and the neck part object block, which is also the range directed by the virtual spray nozzle, the neck part object block should have been the range to be edited. However, the neck part is hidden behind the head part object block in the stereoscopic space. If the neck part object block is determined as the spraying range, the spraying effect does not fit the stereoscopic effect.

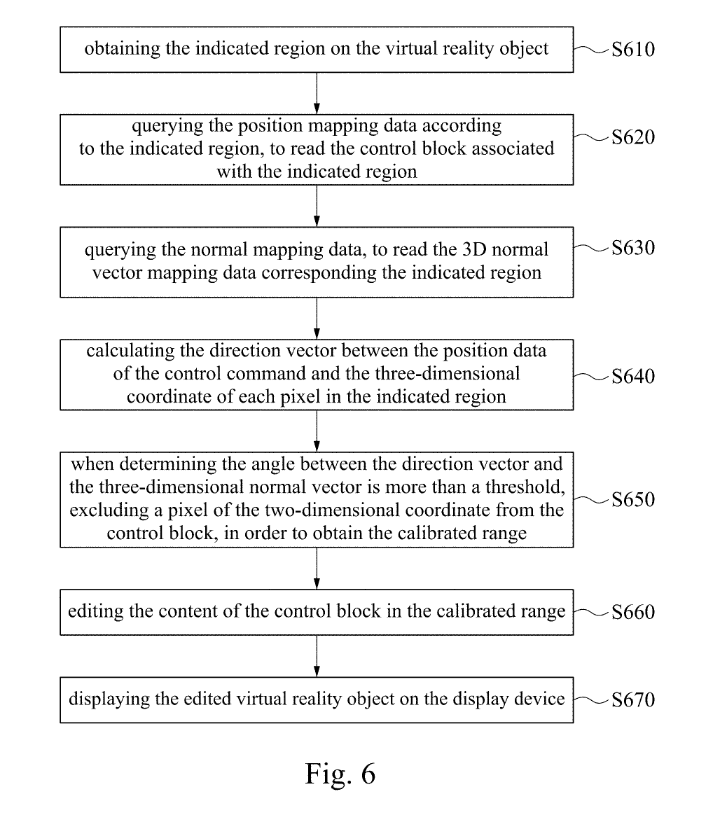

Reference is made to FIG. 6. FIG. 6 is a flowchart illustrating an image processing method in accordance with some embodiments of the present disclosure. Please referring to FIG. 6 with FIG. 1, in step S610, obtaining the indicated region on the virtual reality object according to the control command generated by the controller 700. In step S620, querying the position mapping data according to the indicated region, to read the control block associated with the indicated region. In step S630, querying the normal vector mapping data, to read the 3D normal vector mapping data corresponding to the indicated region, and obtaining the three-dimensional normal vector. In step S640, calculating the direction vector between the position data of the control command and the three-dimensional coordinate of each pixel in the indicated region. In step S650, when determining the angle between the direction vector and the three-dimensional normal vector is more than a threshold, excluding a pixel of the two-dimensional coordinate from the control block, in order to obtain the calibrated range. In step S660, editing the content of the control block in the calibrated range. In step S670, displaying the edited virtual reality object on the display device 110.

It is noted that the above embodiments are simplified for better understanding of the present disclosure. It should be noted that, in some embodiments, the image processing method may be implemented as a computer program. When the computer program is executed by a computer, an electronic device, or the processor 120 in FIG. 1, this executing device performs the image processing method. The computer program can be stored in a non-transitory computer readable storage medium such as a ROM (read-only memory), a flash memory, a floppy disk, a hard disk, an optical disc, a flash disk, a flash drive, a tape, a database accessible from a network, or any storage medium with the same functionality that can be contemplated by persons of ordinary skill in the art to which this disclosure pertains.

As mentioned above, the image processing device and image processing method in the present disclosure can exclude pixels not fit the stereoscopic effect when editing objects in the virtual reality environment (such as spaying the surface of the virtual reality object), to achieve more realistic effect during editing the three-dimensional objects.

Although the present disclosure has been described in considerable detail with reference to certain embodiments thereof, other embodiments are possible. Therefore, the scope of the appended claims should not be limited to the description of the embodiments contained herein.

What is claimed is:

1. A virtual reality device, comprising:
a display device configured to display a virtual reality object;
a processor coupled to the display device and configured to:
receive a control command, and obtain an indicated region on the virtual reality object according to the control command;
read a control block of a 2-dimensional (2D) image associated with the indicated region;
read a 3-dimensional (3D) normal vector mapping data associated with the indicated region;
calibrate a range of the control block according to a position data of the control command and the 3D normal vector mapping data; and
edit, in the calibrated range, a content of the control block according to the received control command.

2. The virtual reality device of claim 1, further comprising:
a storage medium, connected to the processor, configured to store the 2D image, a position mapping data, and the 3D normal vector mapping data;
wherein the virtual reality object comprises a plurality of object blocks, and the 2D image comprises a plurality of texture images, each texture image is corresponding to each object block respectively.

3. The virtual reality device of claim 2, wherein the position mapping data records a two-dimensional coordinate of each pixel of each texture image and a three-dimensional coordinate of each pixel of each object block corresponding to each pixel of each texture image.

4. The virtual reality device of claim 3, wherein the processor is further configured to query the position mapping data according to each pixel of the control block, to obtain the three-dimensional coordinate of each pixel of the indicated region.

5. The virtual reality device of claim 4, wherein the 3D normal vector mapping data records the two-dimensional coordinate of each pixel of each texture image and a three-dimensional normal vector of each pixel of each object block corresponding to each texture image.

6. The virtual reality device of claim 5, wherein the processor is further configured to query the 3D normal vector mapping data by using the two-dimensional coordinate of each pixel in the control block, to obtain the three-dimensional normal vector of each pixel of the object block.

7. The virtual reality device of claim 6, wherein when the processor calibrates the range of the control block, the processor is further configured to:
compute a direction vector between the position data of the control command and the three-dimensional coordinate of each pixel in the indicated region; and
exclude, from the control block, a pixel of the two-dimensional coordinate when an angle between the direction vector and the three-dimensional normal vector is more than a threshold.

8. An image processing method, comprising:
receiving a control command, and obtaining an indicated region on a virtual reality object according to the control command;
reading a control block of a 2D image associated with the indicated region;
reading a 3D normal vector mapping data corresponding to the indicated region;
calibrating a range of the control block according to a position data of the control command and the 3D normal vector mapping data; and
editing, in the calibrated range, a content of the control block according to the received control command.

9. The image processing method of claim 8, wherein the virtual reality object comprises a plurality of object blocks, and the 2D image comprises a plurality of texture images, each texture image is corresponding to each object block respectively.

10. The image processing method of claim 9, wherein a position mapping data records a two-dimensional coordinate of each pixel of each texture image and a three-dimensional coordinate of each pixel of each object block corresponding to each pixel of each texture image.

11. The image processing method of claim 10, further comprising querying the position mapping data according to each pixel of the control block, to obtain the three-dimensional coordinate of each pixel of the indicated region.

12. The image processing method of claim 11, wherein the 3D normal vector mapping data records the two-dimensional coordinate of each pixel of each texture image and a three-dimensional normal vector of each pixel of each object block corresponding to each texture image.

13. The image processing method of claim 12, further comprising querying the 3D normal vector mapping data by using the two-dimensional coordinate of each pixel in the control block, to obtain the three-dimensional normal vector of each pixel of the object block.

14. The image processing method of claim 10, wherein the step of calibrating the range of the control block further comprises:
computing a direction vector between the position data of the control command and the three-dimensional coordinate of each pixel in the indicated region; and
excluding, from the control block, a pixel of the two-dimensional coordinate when an angle between the direction vector and the three-dimensional normal vector is more than a threshold.

15. A non-transitory computer readable storage medium storing one or more programs, comprising instructions, which when executed, causes a processing circuit to perform operations comprising:
receiving a control command, and obtaining an indicated region on a virtual reality object according to the control command;
reading a control block of a 2D image associated with the indicated region;
reading a 3D normal vector mapping data corresponding to the indicated region;
calibrating a range of the control block according to a position data of the control command and the 3D normal vector mapping data; and
editing, in the calibrated range, a content of the control block according to the received control command.

16. The non-transitory computer readable storage medium of claim 15, further comprising instructions, which when executed, causes the processing circuit to further perform operations comprising:
reading the virtual reality object and the 2D image, wherein the virtual reality object comprises a plurality of object blocks, and the 2D image comprises a plurality of texture images, each texture image is corresponding to each object block respectively.

17. The non-transitory computer readable storage medium of claim 16, wherein a position mapping data records a two-dimensional coordinate of each pixel of texture image and a three-dimensional coordinate of each pixel of each object block, the non-transitory computer readable storage medium further comprising instructions, which when executed, causes the processing circuit to further perform operations comprising:
reading the position mapping data, and querying the position mapping data according to each pixel of the control block, to obtain the three-dimensional coordinate of each pixel of the indicated region.

18. The non-transitory computer readable storage medium of claim 17, further comprising instructions, which when executed, causes the processing circuit to further perform operations comprising:
reading the 3D normal vector mapping data, wherein the 3D normal vector mapping data records the two-dimensional coordinate of each pixel of each texture image and a three-dimensional normal vector of each pixel of each object block corresponding to each texture image.

19. The non-transitory computer readable storage medium of claim 18, further comprising instructions, which when executed, causes the processing circuit to further perform operations comprising:
querying the 3D normal vector mapping data by using the two-dimensional coordinate of each pixel in the control block, to obtain the three-dimensional normal vector of each pixel of the object block.

20. The non-transitory computer readable storage medium of claim 19, further comprising instructions, which when executed to calibrate the range of the control block, causes the processing circuit to further perform operations comprising:
computing a direction vector between the position data of the control command and the three-dimensional coordinate of each pixel in the indicated region; and
excluding, from the control block, a pixel of the two-dimensional coordinate when an angle between the direction vector and the three-dimensional normal vector is more than a threshold.
